(19) United States
(12) Patent Application Publication
(10) Pub. No.: US 2010/0272253 A1
(43) Pub. Date: Oct. 28, 2010

(54) INFORMATION PROCESSING DEVICE, OPERATION VERIFYING METHOD, AND PROGRAM

(76) Inventors: Seiichi MATSUDA, Tokyo (JP); Toru Akishita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/759,747

(22) Filed: Apr. 14, 2010

(30) Foreign Application Priority Data
Apr. 23, 2009 (JP) P2009-105585

(51) Int. Cl. H04L 9/30; H04L 9/28

(52) U.S. Cl. 380/30; 380/28

(57) ABSTRACT

An information processing device includes a scalar multiplication operating unit calculating, based on a point P on an elliptic curve E defined on a predetermined defined field, a point Q=s·P by scalar-multiplying the point P and an operation verifying unit verifying whether an equation (P+Q)+G=P+(Q+G) holds by using the point P on the elliptic curve E, the point Q=s·P calculated by the scalar multiplication operating unit, and an arbitrary point G on the elliptic curve E.

### BACKGROUND OF THE INVENTION

1. Field of the Invention

The present invention relates to an information processing device, operation verifying method, and program.

2. Description of the Related Art

Elliptic curve cryptography is an encryption technique using the difficulty of a discrete logarithm problem on an elliptic curve, and has a feature of a shorter key length compared with RSA cryptography under the same safety standards. This elliptic curve cryptography has been used in various scenes, such as in device-to-device authentication with a signature in elliptic curve digital signature algorithm (ECDSA).

A fault attack is an exemplary technique of obtaining in an unauthorized manner by a malicious third party a secret key generated by using elliptic curve cryptography. In this fault attack, by giving an incorrect system parameter or injecting a fault (such as destroying a register retaining an intermediate value) on purpose from the outside during encryption, a malicious third party can obtain an incorrect calculation result to estimate a secret key. Such a fault attack was first suggested by Boneh et al. in 1997 as a differential fault analysis attack (DFA) against RSA cryptography, and was then expanded by Biehl et al. to elliptic curve cryptography.

As a countermeasure against the fault attack, such as DFA, the validity of the calculation result is verified before outputting the calculation result, and the calculation result is not output when it has an incorrect value. An example of a simple countermeasure is rechecking with double calculation, in which the same encrypting process is performed twice and the calculation results are not output when they are not equal to each other. It is assumed in this verification measure that it is difficult to inject exactly the same fault successively twice. However, a calculation cost for repeating the same operation is doubled compared with the case without such a measure, and calculation efficiency is not so desirable. Therefore, a more efficient way to detect a fault is desirable.

As another example of a fault detecting technique, Japanese Unexamined Patent Application Publication No. 2004-252433 describes a method in which a right side and a left side of an equation representing an elliptic curve are separately calculated for a point (X, Y) obtained by an operation and it is determined whether the left side is equal to the right side, thereby determining whether a fault attack is present.

### SUMMARY OF THE INVENTION

However, in the method described in Japanese Unexamined Patent Application Publication No. 2004-252433 mentioned above, a function of calculating values corresponding to the right side and left side of the equation representing an elliptic curve and a function of comparing the obtained two types of values have to be separately provided. Therefore, when the method described in Japanese Unexamined Patent Application Publication No. 2004-252433 is implemented as hardware, provision of a special processing unit disadvantageously increases the circuit size. When the above method is implemented as software, calculation cost is disadvantageously increased.

It is desirable to provide an information processing device, operation verifying method, and program capable of determining whether a fault attack is present with a simpler technique.

According to an embodiment of the present invention, an information processing device is provided including a scalar multiplication operating unit calculating, based on a point P on an elliptic curve E defined on a predetermined defined field, a point Q=s·P by scalar-multiplying the point P and an operation verifying unit verifying whether equation (1) below holds by using the point P on the elliptic curve E, the point Q=s·P calculated by the scalar multiplication operating unit, and an arbitrary point G on the elliptic curve E.

(P+Q)+G=P+(Q+G) (1)

According to the structure described above, the scalar multiplication operation unit calculates, based on the point P on the elliptic curve E defined on the predetermined defined field, the point Q=s·P by scalar-multiplying the point P. The operation verifying unit verifies whether equation (1) holds by using the point P on the elliptic curve E, the point Q=s·P calculated by the scalar multiplication operating unit, and the arbitrary point G on the elliptic curve E.

The elliptic curve E is preferably an elliptic curve E_{A}: y²=x³+ax+b (a, bεF_{q}) defined on a finite field F_{q} (q=p^{m}, mεN, p>3) or an elliptic curve E_{B}: y²+xy=x³+a₂x²+a₆ (a₂, a₆εF_{2̂m}) defined on a finite field F_{2̂m} (mεN) of a characteristic of 2.

When equation (1) does not hold, the operation verifying unit determines that the point P does not have a suitable value or the point Q has been tampered.

Preferably, the information processing device further includes a storage unit storing hidden information to be hidden by the information processing device, and the arbitrary point G on the elliptical curve E is stored in the storage unit as the hidden information.

The storage unit stores a secret key d held by the information processing device, and the scalar multiplication operating unit may use the secret key d as a coefficient s for a scalar multiplication operation.

The operation verifying unit may verify whether equation (1) holds by using a public key held by the information processing device or a public key held by another reliable information processing device, in place of the point P or the point Q.

According to another embodiment of the present invention, an operation verifying method is provided including the steps of calculating, based on a point P on an elliptic curve E defined on a predetermined defined field, a point Q=s·P by scalar-multiplying the point P and verifying whether equation (1) holds by using the point P on the elliptic curve E, the calculated point Q=s·P, and an arbitrary point G on the elliptic curve E.

According to still another embodiment of the present invention, a program is provided causing a computer to perform a function of calculating, based on a point P on an elliptic curve E defined on a predetermined defined field, a point Q=s·P by scalar-multiplying the point P and to perform a function of verifying whether equation (1) holds by using the point P on the elliptic curve E, the point Q=s·P calculated by the scalar multiplication operation function, and an arbitrary point G on the elliptic curve E.

As described above, according to the embodiments of the present invention, the presence or absence of a fault attack can be determined with a simpler technique by using the property of a group on the elliptic curve.

### BRIEF DESCRIPTION OF THE DRAWINGS

FIG. 1 illustrates the structure of an information processing device according to an embodiment of the present invention;

FIG. 2 is a flowchart illustrating an operation verifying method according to another embodiment;

FIG. 3 illustrates the hardware structure of the information processing device;

FIG. 4 illustrates an example of an algorithm for a scalar multiplication operation;

FIG. 5 is a flowchart illustrating an attack using a small order; and

FIG. 6 is a flowchart illustrating an attack that injects a fault in a scalar multiplication operation.

### DESCRIPTION OF THE PREFERRED EMBODIMENTS

With reference to the attached drawings, preferred embodiments of the present invention are described in detail below. Here, in the specification and drawings, components having a substantially identical functional structure are provided with the same reference numeral to prevent redundant description.

Here, description is made in the order below.

### (1) Elliptic Curve

### (2) Fault Attack

### (3) Embodiments

(3-1) Structure of the Information Processing Device

(3-2) Operation Verifying Method

### (4) Hardware Structure

### (5) Conclusion

### Elliptic Curve

First, prior to the description of the information processing device and operation verifying method according to embodiments of the present invention, an elliptic curve for use in the embodiments of the present invention is described in detail.

In the information processing device and operation verifying method according to the embodiments of the present invention, two elliptic curves are used as elliptic curves E.

(i) An elliptic curve E_{A}: y²=x³+ax+b (a, bεF_{q}) defined on a finite field F_{q} (q=p^{m}, mεN, p>3).
(ii) An elliptic curve Eₛ: y²+xy=x³+a₂x²+a₆ (a₂, a₆εF_{2̂m}) defined on a finite field (binary field) F_{2̂m}(mεN) with a characteristic of 2.

In the description below, by way of example, the elliptic curve E_{A} defined on the finite field with a characteristic of p>3 is considered. The same description goes for the elliptic curve E_{B} defined on the finite field with a characteristic of 2.

A set of points on the elliptic curve E_{A} is represented by E(F_{q})={(x, y) εF_{q}×F_{q}|y²=x³+ax+b}∪{O}, where O is a point of infinity, which is an identity element of E(F_{q}) in an addition described further below.

The concentration of E(F_{q}) is referred to as an order of the elliptic curve, and is represented by #E(F_{q})=h·r, where r is a prime number, and h is a coefficient called a cofactor and it is assumed herein that h=1. When a point on the elliptic curve selected in a random manner is taken as a base point G, the order of G is r because the order of the elliptic curve is assumed to have a prime number.

Here, the coefficients in the equation representing the elliptic curve, the order p of the defined field, the order r of the base point, and the base point G are elliptic-curve parameters for specifying the elliptic curve.

Next, an addition between two points that are present on the elliptic curve is described.

In the elliptic curve E_{A}, an addition between a point P₁=(x₁, y₁) and a point P₂=(x₂, y₂) that are present on the elliptic curve is defined as follows, where P₃=(x₃, y₃)=P₁+P₂.

$$\begin{matrix}{x}_{3} = {λ}^{2} - {x}_{1} - {x}_{2} & ( 11 ) \\ {y}_{3} = ( {x}_{1} - {x}_{3} ) λ - {y}_{1} & ( 12 ) \\ λ = \{ \begin{matrix}\frac{{y}_{2} - {y}_{1}}{{x}_{2} - {x}_{1}} & ( {P}_{1} \neq {P}_{2} ) \\ \frac{3 {x}_{1}^{2} + a}{2 {y}_{1}} & ( {P}_{1} = {P}_{2} )\end{matrix} & ( 13 )\end{matrix}$$

Here, E(F_{q}) satisfies four group properties below.

1. Closed rule: P+QεE(F_{q}) for all P, QεE(F_{q})

2. Presence of identity element: P+O=O+P=P for all PεE (F_{q})

3. Presence of inverse element: P+(−P)=(−P)+P=O for all PεE (F_{q})

4. Associative law: (P+Q)+R=P+(Q+R) for all P, Q, RεE (F_{q})

Also, a point obtained by scalar-multiplying a point P by s is represented by sP, and is defined as below. That is, as evident from an equation below, the point sP is defined as a point obtained by adding the point P to the point P (s−1) times.

$$sP = {\underbrace{P + P + ⋯ + P + P}}_{s} \qquad ( 14 )$$

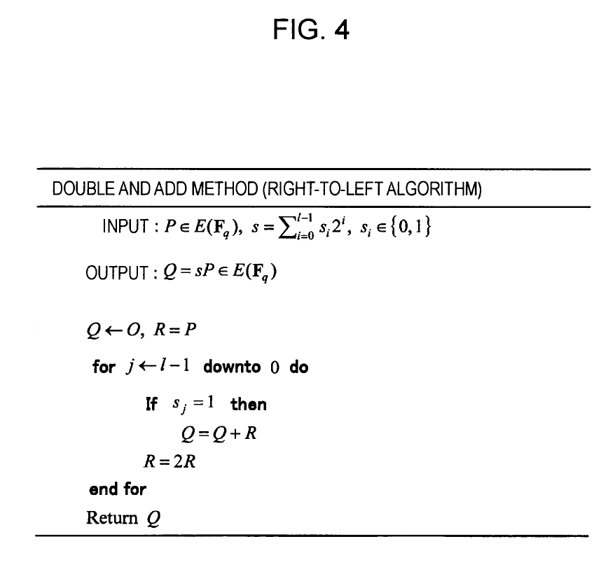

An example of a calculation algorithm for performing such a scalar multiplication operation as described above is a double and add method as depicted in FIG. 4.

Similarly, in the elliptic curve E_{B}, an addition between a point P₁=(x₁, y₁) and a point P₂=(x₂, y₂) present on the elliptic curve is defined as follows, where P₃=(x₃, y₃)=P₁+P₂. Here, addition is defined as in equations (15) to (17) below when P₁≠P₂, and addition is defined as in equations (18) to (20) below when P₁=P₂.

$$\begin{matrix}{x}_{3} = {λ}^{2} + λ + {x}_{1} + {x}_{2} + {a}_{2} & ( 15 ) \\ {y}_{3} = ( {x}_{1} + {x}_{3} ) λ + {x}_{3} + {y}_{1} & ( 16 ) \\ λ = \frac{{y}_{1} + {y}_{2}}{{x}_{1} + {x}_{2}} & ( 17 ) \\ {x}_{3} = {λ}^{2} + λ + {a}_{2} & ( 18 ) \\ {y}_{3} = ( {x}_{1} + {x}_{3} ) λ + {x}_{3} + {y}_{1} & ( 19 ) \\ λ = \frac{{y}_{1}}{{x}_{1}} + {x}_{1} & ( 20 )\end{matrix}$$

Here, a problem of finding s from the provided these two values P and sP is referred to as an elliptic curve discrete logarithm problem (ECDLP). This ECDLP is extremely difficult to be solved when the order of P is sufficiently large, and this difficulty is a base for the safety of elliptic curve cryptography.

### Fault Attack

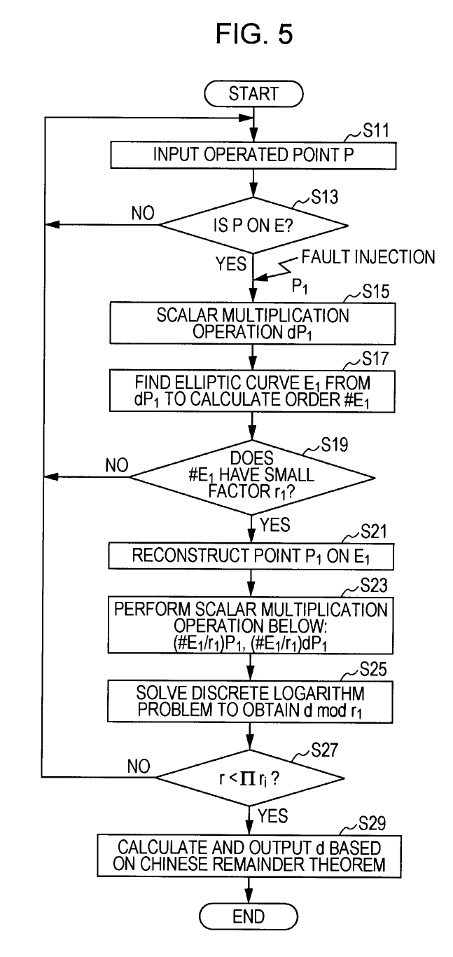

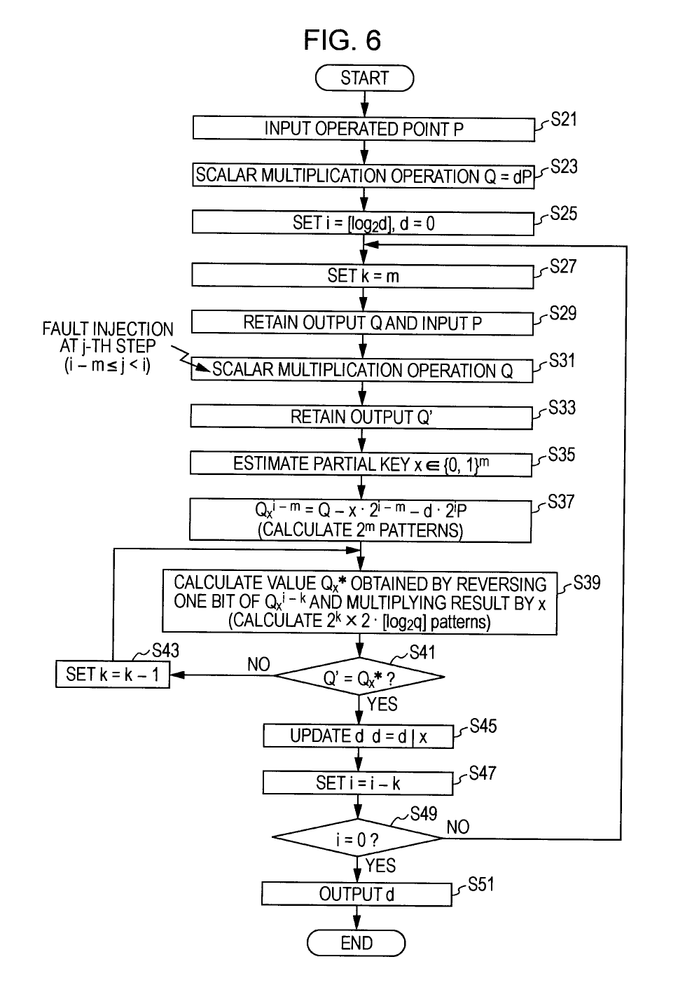

Next, with reference to FIGS. 5 and 6, typical two types of fault attack are described in detail. FIG. 5 is a flowchart illustrating an attack using a small order. FIG. 6 is a flowchart illustrating an attack that injects a fault in a scalar multiplication operation.

Biehl et al. suggest that there are two types of attacking technique as below for a scalar multiplication operation of calculating dP by multiplying an input P by secret information d, depending on the timing of injecting a fault. There are two timings of injecting a fault: before and during a scalar multiplication operation.

First, an attack that injects a fault before a scalar multiplication operation is described.

This attack that injects a fault before a scalar multiplication operation is called a small order point attack, which is described in detail with reference to FIG. 5. In the description below, it is assumed that the elliptic curve E is represented by y²=x³+ax+b defined on a finite field with a characteristic of p>3.

An attacker inputs information about an operated point PεE(F_{q}) to a device performing a scalar multiplication operation (step S11) to cause the device to determine whether this operated point P is on the correct elliptic curve E (that is, y²=x³+ax+b) (step S13).

Immediately after it is determined that the operated point P is on the correct elliptic curve E, the attacker injects a fault to reverse one bit of an x or y component of the point P (fault injection). When the point with its one bit reversed as a result of the injection is taken as P₁, this point P₁ is on an elliptic curve E₁: y²+x³+ax+b₁, and a scalar multiplication output dP₁ is calculated by the device performing a scalar multiplication operation on the elliptic curve E₁ (step S15). Here, as evident from equations (11) to (13), no coefficient b defining an elliptic curve appears in any addition and doubling of the points on the elliptic curve. Therefore, the scalar multiplication output dp₁ for the point P₁ can be correctly calculated.

The attacker obtaining the scalar multiplication output dp₁ finds the elliptic curve E₁ from the x and y coordinates of the scalar multiplication output dp₁ to calculate an order #E₁ (step S17). The attacker then determines whether the order #E₁ has a factor r₁ that is small to some extent (step S19).

Since either one of the x and y components of the point P₁εE₁ has a correct value before a fault is injected, the attacker substitutes the x or y component into the elliptic curve E₁, thereby reconstructing P₁ (step S21). The attacker then multiplies P₁ and dp₁ each by (#E₁/r₁) (step S23), and then maps the multiplication result on a subgroup E₁(F_{q})[r₁] of the order r₁. Next, the attacker solves a discrete logarithm problem by using the calculated (#E₁/r₁)P₁ and (#E₁/r₁)dP₁ to obtain d mod r₁ (step S25).

The attacker then repeats the procedure described above on another elliptic curve Eᵢ with a prime number rᵢ that is different from r₁ and small to some extent as an order, and collects d mod rᵢ representing partial information of the secret information d until r<Πrᵢ(step S27). Finally, the attacker applies the Chinese remainder theorem to d mod rᵢ to derive the secret information d (step S29). As described above, by using a fault attack according to the above-described procedure, the attacker has a possibility of obtaining the secret information d.

The description above is made to an attack that injects a fault before a scalar multiplication operation.

Next, an attack that injects a fault during a scalar multiplication operation is described in detail with reference to FIG. 6.

It is assumed herein that the device performing a scalar multiplication operation performs a scalar multiplication operation by using the right-to-left algorithm depicted in FIG. 4.

The attacker first inputs the operated point P to the device performing a scalar multiplication operation (step S21) to cause the device performing a scalar multiplication operation to perform a scalar multiplication operation (step S23), thereby obtaining a correct scalar multiplication point Q=dP.

Next, the attacker sets a parameter i at a maximum integer not exceeding log₂d, and then sets d=0 (step S25). The attacker then sets a parameter k at a number of bits m desired to be estimated (step S27).

Next, while keeping the obtained correct scalar multiplication point Q, the attacker again inputs P to the device performing a scalar multiplication operation as an operated point (step S29).

The device performing a scalar multiplication operation performs a scalar multiplication operation based on the input operated point P (step S31). At some timing, the attacker injects a fault (one-bit reversal) to a register retaining an intermediate value of the scalar multiplication operation. In the example depicted in FIG. 6, the attacker performs a fault injection at a j-th step satisfying I−m≦j<i to cause the device performing a scalar multiplication operation to generate an incorrect operation result Q′. The attacker holds calculation result Q′ output from the device performing a scalar multiplication operation (step S33).

The attacker then estimates part of the secret key (partial key x) from the known bit of the secret key to the fault-injected position (step S35) to perform an inverse operation from Q to an intermediate value Qₓⁱ at an i-th step where the fault was injected (step S37) based on equation (901) below. This inverse operation is performed for 2^{m} patterns.

Qₓ^{i-m}=Q−x·2^{i-m}−d·2ⁱP (901)

Next, the attacker calculates Qₓ*, by reversing one bit of Qₓ^{i-k} and multiplying the result by x (step S39). Here, x is an estimated partial key. The attacker then compares the calculated Qₓ* and the incorrect result Q′ (step S41). When Q′ and Qₓ* are not equal to each other, the attacker sets the parameter k as k−1 (step S43), and then again calculates Qₓ* (step S39). In this manner, since the attacker does not know which one bit of the intermediate value Qₓⁱ has been reversed by the fault, the attacker calculates all candidates Qₓ* of the incorrect result Q′ for all conceivable fault patterns by using the estimated secret key.

On the other hand, when Q′ and Qₓ* are equal to each other, the estimation of the partial key x is correct. Thus, the attacker updates the parameter d by setting the parameter d at a value obtained by dividing d by x (d|x) (step S45). The attacker then sets the parameter i at i−k (step S47) to determine whether the parameter i becomes 0 (step S49). When the parameter i is not 0, the attacker returns to step S27 to perform a process again from step S27 for the next m bits. When the parameter i becomes 0, this means that the entire secret key has been reconstructed, and therefore the estimated entire secret key d is output (step S51).

For example, consider the case of estimating upper four bits of the secret key d. In this case, while the device performing a scalar multiplication operation is performing a scalar multiplication operation with these bits, the attacker performs a fault injection. Here, when the bit length of d is assumed to be 160 bits, a fault-injected step i is 156≦i<160. Assuming that the fault was injected at a 156-th step, the attacker reconstructs an intermediate value Q¹⁵⁶ at the 156-th step. The attacker calculates Qₓⁱ=Q−x·2¹⁵⁶P for all conceivable partial-key candidates xε{0, 1}⁴. The attacker performs one-bit reversal on all Qₓ¹⁵⁶, and then multiplies the reversal results by x to calculate Qₓ*. When this Qₓ* matches the obtained incorrect result Q′, the estimated partial key x, the fault-injected step i=156, and the reversed bit position are correct. On the other hand, when no Qₓ* matching the incorrect result Q′ is present, the attacker takes i=157 to obtain all one-bit-reversed Qₓ¹⁵⁷ in a manner similar to that when i=156 to proceed the process. In this manner, key estimation is performed for each block in which a fault is injected into an intermediate value, and the process is repeated until the entire secret key d is reconstructed.

The description above is made to an attack that injects a fault during a scalar multiplication operation.

Whether such a fault attack is performed by an attacker is verified by verifying the validity of an exponentiation point, which is an output from a scalar multiplication operation. Based on the verification result, the effect of the fault attack can be suppressed. In the description above, the elliptic curve E_{A} defined on the finite field with a characteristic of p>3 is taken as an example. However, there is a possibility that a similar fault attack may be performed by an attacker on the elliptic curve E_{B} defined on the finite field with a characteristic of 2.

In an information processing device and operation verifying method according to the embodiments of the present invention described below, the presence or absence of a fault attack as described above can be easily verified irrespectively of the type of elliptic curve. The information processing device and operation verifying method according to the embodiments of the present invention is described in detail below.

### Embodiments

### Structure of the Information Processing Device

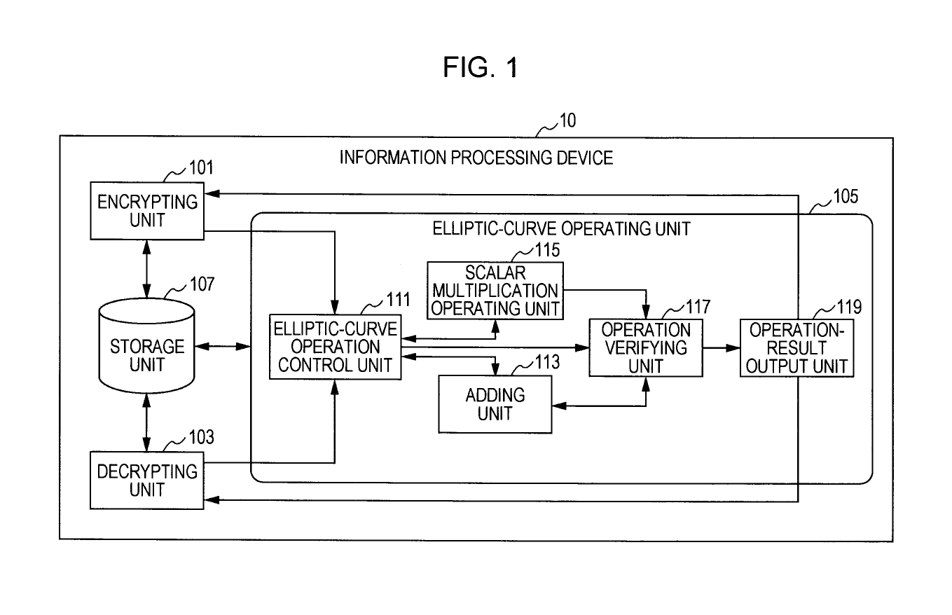

Next, an information processing device according to an embodiment of the present invention is described in detail. FIG. 1 is a block diagram of the structure of the information processing device according to the embodiment.

An information processing device 10 according to the embodiment mainly includes, for example, as depicted in FIG. 1, an encrypting unit 101, a decrypting unit 103, an elliptic-curve operating unit 105, a storage unit 107.

The encrypting unit 101 is implemented by, for example, a central processing unit (CPU), a read only memory (ROM), a random access memory (RAM), or a communication device. The encrypting unit 101 encrypts plain text desired to be encrypted based on an encryption technique using the elliptical curve E defined on a predetermined finite field to generate encrypted text.

In more detail, in an encrypting process of encrypting plain text to encrypted text, the encrypting unit 101 requests the elliptic-curve operating unit 105 to perform an elliptic-curve operation process using the elliptic curve E. Examples of this elliptic-curve operation include an addition between points on the elliptic curve E and a scalar multiplication operation of scalar-multiplying a point on the elliptic curve E.

When requesting the elliptic-curve operating unit 105 to perform an elliptic-curve operation, the encrypting unit 101 transmits, as operation parameters, points on the elliptic curve necessary for performing an elliptic-curve operation and various parameters necessary for the operation (for example, coefficients in a scalar multiplication operation). When the result of the operation using the elliptic curve is transmitted from the elliptic-curve operating unit 105, the encrypting unit 101 uses the operation result to continue the encrypting process.

Upon ending the encrypting process, the encrypting unit 101 transmits the generated encrypted text to a predetermined device.

The decrypting unit 103 is implemented by, for example, a CPU, a ROM, a RAM, or a communication device. The decrypting unit 103 decrypts encrypted text based on the encryption technique using the elliptic curve E defined the predetermined finite field to generate plain text.

In more detail, in a decrypting process of decrypting encrypted text to plain text, the decrypting unit 103 requests the elliptic-curve operating unit 105 to perform an elliptic-curve operation process using the elliptic curve E. Examples of this elliptic-curve operation include an addition between points on the elliptic curve E and a scalar multiplication operation of scalar-multiplying a point on the elliptic curve E.

When requesting the elliptic-curve operating unit 105 to perform an elliptic-curve operation, the decrypting unit 103 transmits, as operation parameters, points on the elliptic curve necessary for performing an elliptic-curve operation and various parameters necessary for the operation (for example, coefficients in a scalar multiplication operation). When the result of the operation using the elliptic curve is transmitted from the elliptic-curve operating unit 105, the decrypting unit 103 uses the operation result to continue the decrypting process.

Upon ending the decrypting process, the decrypting unit 103 displays the generated plain text on a display device, such as a display, provided to the information processing device 10.

The elliptic-curve operating unit 105 is implemented by, for example, a CPU, a ROM, or a RAM. Based on the elliptic curve E defined on the predetermined finite field and the operation parameters transmitted from the encrypting unit 101 or the decrypting unit 103, the elliptic-curve operating unit 105 performs an operation process using the elliptic curve. The elliptic-curve operating unit 105 further includes an elliptic-curve operation control unit 111, an adding unit 113, a scalar multiplication operating unit 115, an operation verifying unit 117, and an operation-result output unit 119.

The elliptic-curve operation control unit 111 is implemented by, for example, a CPU, a ROM, or a RAM. Based on the operation parameters transmitted from the encrypting unit 101 and the decrypting unit 103, elliptic-curve operation control unit 111 controls the elliptic-curve operation requested from the encrypting unit 101 and the decrypting unit 103.

In more detail, the elliptic-curve operation control unit 111 refers to the operation parameters transmitted from the encrypting unit 101 and the decrypting unit 103 to determine the type of the elliptic-curve operation requested from these processing units. Upon specifying the type of elliptic-curve operation requested from the encrypting unit 101 and the decrypting unit 103, the elliptic-curve operation control unit 111 transmits the obtained operation parameters to the adding unit 113 and scalar multiplication operating unit 115, which will be described further below, according to the specified type of elliptic-curve operation. The elliptic-curve operation control unit 111 also transmits the specified type of elliptic-curve operation to the operation verifying unit 117, which will be described further below.

The adding unit 113 is implemented by, for example, a CPU, a ROM, or a RAM. Based on the information regarding the points on the elliptic curve E included in the operation parameters transmitted from the elliptic-curve operation control unit 111, the adding unit 113 performs an addition for the operated point on the elliptic curve. Specifically, the adding unit 113 performs an addition for the operated point by using equations (11) to (13) or equations (15) to (20) according to the type of the elliptic curve E for use in the operation. In the addition process, the adding unit 113 may refer to elliptic-curve parameters, a public key, a secret key, and others stored in the storage unit 107 and others.

Upon obtaining the operation result of the addition for the operated point, the adding unit 113 notifies the elliptic-curve operation control unit 111 that the addition process has ended. The adding unit 113 transmits the operation result of the addition for the operated point (that is, information about the point on the elliptic curve E obtained as a result of the addition) to the operation verifying unit 117, which will be described further below. The adding unit 113 may transmit the operation result to the scalar multiplication operating unit 115, which will also be described further below, and the operation result may be used for the scalar multiplication operation process in the scalar multiplication operating unit 115.

The scalar multiplication operating unit 115 is implemented by, for example, a CPU, a ROM, or a RAM. Based on the information about the operated point on the elliptic curve E included in the operation parameters transmitted from the elliptic-curve operation control unit 111 and the information about the coefficients of the scalar multiplication operation, the scalar multiplication operating unit 115 performs a scalar multiplication operation for the operated point. That is, the scalar multiplication operating unit 115 is a processing unit that calculates Q=s·P where the operated point is P, the coefficient of the scalar multiplication operation is s, and the scalar multiplication operation result (also referred to below as an exponentiation point) is Q.

The scalar multiplication operating unit 115 performs a scalar multiplication operation for the operated point by executing a calculation algorithm, such as the double and add method depicted in FIG. 4, for example. The calculation algorithm performed by the scalar multiplication operating unit 115 is not restricted to the example above, and another arbitrary calculation algorithm can be used.

In a scalar multiplication operation process, the scalar multiplication operating unit 115 may refer to the elliptic-curve parameters stored in the storage unit 107 or the like, the public key, the secret key, and the like. For example, as the coefficient s of the scalar multiplication operation, the scalar multiplication operating unit 115 can use the secret key hidden by the information processing device itself and the public key managed by the information processing device itself.

Upon obtaining the operation result of the scalar multiplication operation for the operated point, the scalar multiplication operating unit 115 notifies the elliptic-curve operation control unit 111 that the scalar multiplication operation process has ended. The scalar multiplication operating unit 115 also transmits the operation result of the scalar multiplication operation for the operated point (that is, information about the point on the elliptic curve E obtained as a result of the scalar multiplication operation) to the operation verifying unit 117, which will be described further below. The scalar multiplication operating unit 115 may transmit the operation result to the adding unit 113, and the operation result may be used in an addition process in the adding unit 113.

The operation verifying unit 117 is implemented by, for example, a CPU, a ROM, or a RAM. When the scalar multiplication operating unit 115 performs the scalar multiplication operation, the operation verifying unit 117 verifies a scalar multiplication operation process performed by the scalar multiplication operating unit 115. In more detail, based on the operated point P in the scalar multiplication operation, the point (exponentiation point) Q on the elliptic curve E obtained as a result of the scalar multiplication operation, and the base point G as an elliptic-curve parameter, the operation verifying unit 117 verifies whether equation (101) below holds.

(P+Q)+G=P+(Q+G) (101)

Specifically, the operation verifying unit 117 requests the adding unit 113 to perform the addition process in the left side of equation (101) and the addition process in the right side of equation (101). The operation verifying unit 117 determines whether the operation result on the left side and the operation result on the right side transmitted from the adding unit 113 have the same value (that is, whether these operation results represent the same point on the elliptic curve E), thereby verifying whether equation (101) holds.

The operation verifying unit 117 verifies whether equation (101) holds, thereby verifying both of the operated point P and the exponentiation point Q representing the scalar multiplication operation result.

First, verification of the exponentiation point Q is described in more detail.

When it is assumed that a fault is injected to change the scalar-multiplication operation result to the incorrect point Q′ while the scalar multiplication operating unit 115 is calculating the exponentiation point Q, the exponentiation point Q′ to be obtained as a result of the operation is on the elliptic curve E′, which is different from the correct elliptic curve E. That is, QεE′(F_{q}). The associative law of the group represented as equation (101) holds for three points P, Q, and GεE(F_{q}) on the same elliptic curve. Therefore, when equation (101) holds, the operation verifying unit 117 confirms that the operated point P, the exponentiation point Q, and the base point G are on the same elliptic curve E. Conversely, when equation (101) does not hold, this indicates that the exponentiation point Q belongs to a group different from that of an addition group E(F_{q}) (that is, the exponentiation point Q is on an elliptic curve different from that of the operated point P and the base point G). Therefore, the operation verifying unit 117 detects a fault injected by an attacker during a scalar multiplication operation.

Next, verification of the operated point P is described in detail.

When the operated point is changed to P′εE′(F_{q}) before the scalar multiplication operating unit 115 performs a scalar multiplication operation, the obtained scalar-multiplication operation result is Q′εE′(F_{q}), which belongs to a group different from that of the base point GεE(F_{q}). Therefore, when an injection by an attacker or a fault in the information processing device 10 changes the operated point P, the operation verifying unit 117 can verify that the operated point P does not have a suitable value.

Here, in the verification as described above, which of the operated point P and the exponentiation point Q is not suitable is not clarified. To get around this, by performing a process as described below, the operation verifying unit 117 can clarify which of the operated point P and the exponentiation point Q is not suitable.

For example, when only the operated point P is desired to be verified, the operation verifying unit 117 uses a public key managed by the information processing device itself or a public key of another reliable information processing device in place of the exponentiation point Q to verify whether equation (101) holds. Since these public keys are calculated by using the same elliptic curve as the elliptic curve where the operated point P is present, they belong to the same group as that of the operated point P. Therefore, by using these public keys in place of the exponentiation point Q, only the operated point P can be verified. Examples of another reliable information processing device include an information processing device held by a key generation center that generates a key pair formed of a public key and a secret key and an information processing device held by a third-party certification authority.

When only the exponentiation point Q is desired to be verified, as with the verification of only the operated point P, the operation verifying unit 117 can use the public key managed by the information processing device itself or the public key of another reliable information processing device in place of the operated point P to verify whether equation (101) holds.

The scalar multiplication operating unit 115 may perform a scalar multiplication operation, such as a scalar multiplication operation for the base point G, without the operated point P being specified. In this case, in place of the operated point P, the operation verifying unit 117 can use the public key managed by the information processing device itself or the public key of another reliable information processing device to verify whether equation (101) holds.

As described above, when equation (101) does not hold, the operation verifying unit 117 can determine that the operated point P does not have a suitable value or that the exponentiation point Q has been tampered. The operation result can be verified by comparing the points on the elliptic curve in one operation based on the results of four additions by the adding unit 113. Therefore, in the information processing device according to the embodiment, the presence or absence of a fault attack can be determined with a simpler technique by using the property of a group on the elliptic curve.

Upon obtaining the verification result of the scalar multiplication operation, the operation verifying unit 117 transmits the obtained verification result to the operation-result output unit 119, which will be described further below. In more detail, when the result of the addition performed by the adding unit 113 is transmitted, the operation verifying unit 117 transmits the addition result to the operation-result output unit 119. Also, when the scalar multiplication operation result is transmitted from the scalar multiplication operating unit 115, the operation verifying unit 117 performs verification by using equation (101). When verification is successful, the operation verifying unit 117 transmits the operation result of the scalar multiplication operation and the obtained verification result to the operation-result output unit 119. When verification of the scalar multiplication operation fails, the operation verifying unit 117 notifies the operation-result output unit 119 that verification has failed.

The operation-result output unit 119 is implemented by, for example, a CPU, ROM, or RAM. The operation-result output unit 119 outputs the operation result and the verification result transmitted from the operation verifying unit 117 to a processing unit requesting the elliptic-curve operating unit 105 to perform an elliptic-curve operation process.

The storage unit 107 stores the secret key and the public key managed by the information processing device 10 and the elliptic-curve parameters. The storage unit 107 can also store as appropriate various parameters and information about the progress of the process used by the information processing device 10 in performing some process, various databases, and others. Each processing unit included in the information processing device 10 according to the embodiment can freely read from and write into the storage unit 107.

As described above, in the information processing device 10 according to the embodiment, when there is a possibility that a fault may have been injected during encryption to change an intermediate value, the validity of the result of the scalar multiplication operation can be easily verified irrespectively of the type of elliptic curve.

An example of functions of the information processing device 10 according to the embodiment has been described above. Each component described above may be configured by using a general-purpose member or circuit, or may be configured of hardware specific to the function of each component. Also, all of the functions of the respective components may be performed by a CPU or the like. Therefore, the configuration for use can be changed as appropriate according to the technical level at the time of implementing the embodiment.

Here, a computer program for achieving each function of the information processing device according to the embodiment as described above can be fabricated and implemented on a personal computer or the like. Furthermore, a computer-readable recording medium storing such a computer program as described above can be provided. Examples of the recording medium include a magnetic disk, an optical disk, a magneto-optical disk, and a flash memory. Still further, the computer program described above may be distributed, for example, over a network, without using a recording medium.

### Operation Verifying Method

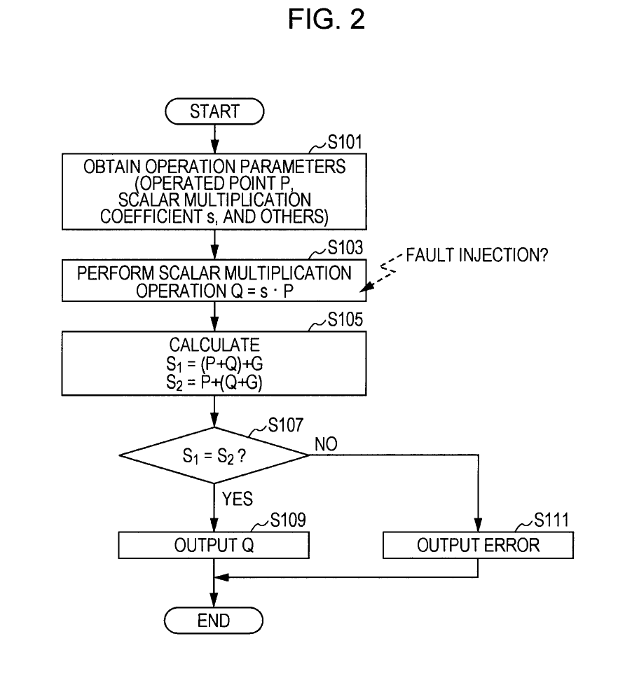

Next, with reference to FIG. 2, an operation verifying method according to an embodiment is described in detail. FIG. 2 is a flowchart illustrating the operation verifying method according to the embodiment.

The encrypting unit 101 or the decrypting unit 103 of the information processing device 10 requests the elliptic-curve operating unit 105 to perform a scalar multiplication operation when a scalar multiplication operation on a point on an elliptic curve is desired to be performed for a process to be performed by any processing unit of the encrypting unit 101 or the decrypting unit 103. At this time, the encrypting unit 101 and the decrypting unit 103 transmit, to the elliptic-curve operating unit 105, operation parameters including information about the operated point P and information about the coefficient s of the scalar multiplication operation.

The elliptic-curve operation control unit 111 of elliptic-curve operating unit 105 obtains the operation parameters transmitted from the encrypting unit 101 or the decrypting unit 103 (step S101) to grasp the operated point P in the requested elliptic-curve operation and the coefficient s of the scalar multiplication operation. The elliptic-curve operation control unit 111 then transmits the obtained operated point P and the coefficient s of the scalar multiplication operation to the scalar multiplication operating unit 115.

The scalar multiplication operating unit 115 performs a scalar multiplication operation Q=s·P based on the operation parameters transmitted from the elliptic-curve operation control unit 111 (step S103). When the scalar multiplication operation process ends, the scalar multiplication operating unit 115 notifies the elliptic-curve operation control unit 111 that the scalar multiplication operation process has ended, and also transmits the information about the exponentiation point Q representing the operation result to the operation verifying unit 117.

When the operation result is transmitted from the scalar multiplication operating unit 115, the operation verifying unit 117 requests the adding unit 113 to perform additions of two types below.

S₁=(P+Q)+G (102)

S₂=P+(Q+G) (103)

Upon request from the operation verifying unit 117 to perform additions of two types represented by S₁ and S₂ mentioned above, the adding unit 113 performs additions based on equations (102) and (103) (step S105), and then transmits the operation results to the operation verifying unit 117.

Based on the values S₁ and S₂ transmitted from the adding unit 113, the operation verifying unit 117 verifies whether S₁=S₂ holds (that is, whether equation (101) holds) (step S107).

When S₁=S₂ holds, the operation verifying unit 117 determines that the exponentiation point Q has been suitably calculated, and transmits the operation result and verification result of the scalar multiplication operation to the operation-result output unit 119. The operation-result output unit 119 obtaining the operation result and the verification result then outputs the operation result Q to the processing unit requesting the execution of the elliptic-curve operation (step S109).

On the other hand, when S₁=S₂ does not hold, the operation verifying unit 117 determines that the exponentiation point Q has not been suitably calculated, and transmits this determination result to the operation-result output unit 119. The operation-result output unit 119 obtaining the verification result then outputs an error indicating that the exponentiation point Q has not been suitably calculated to the processing unit requesting the execution of the elliptic-curve operation (step S111).

As described above, in the operation verifying method according to the embodiment, the operation result can be verified only with two additions on the left side of equation (101), two additions on the right side of equation (101), and one operation of comparing points. Therefore, in the operation verifying method according to the embodiment, the validity of the operation result of the scalar multiplication operation can be easily verified irrespectively of the type of elliptic curve without performing a complex process, such as calculation of exponentiation of a predetermined value.

Also, in the operation verifying method according to the embodiment, the addition/comparison process on the elliptic curve can also be used without a comparison process in the finite field. Therefore, when the operation verifying method according to the embodiment is implemented as hardware, the circuit size for the operation verifying method can be small-sized. Also, in the operation verifying method according to the embodiment, the operated point P and the exponentiation point Q can both be verified together, thereby simplifying the step of verifying the input value and the output value more than the technique in the past. As a result, when the operation verifying method according to the embodiment is implemented as software, calculation cost can be reduced.

### Hardware Structure

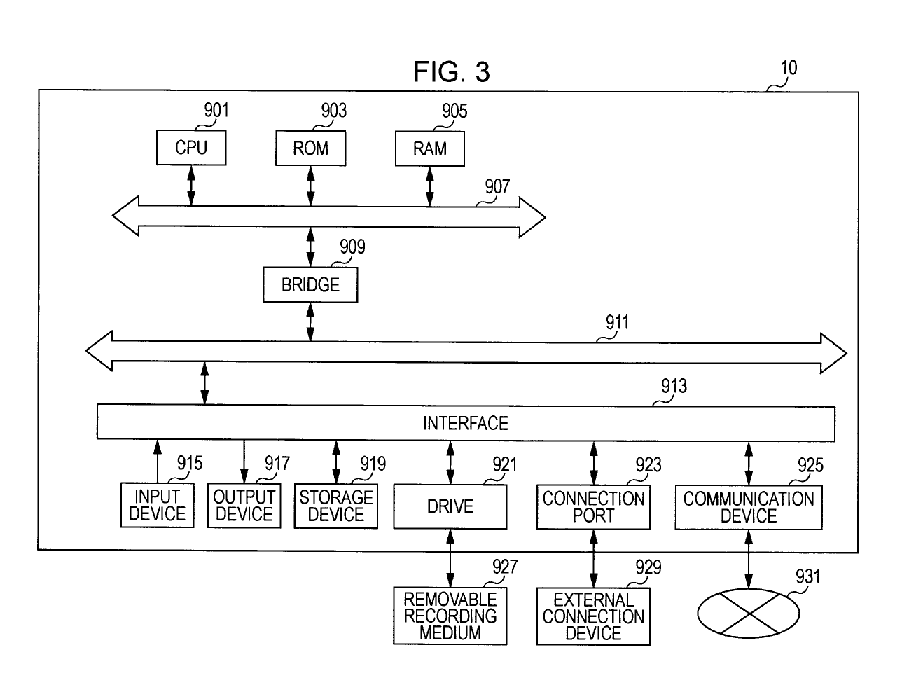

Next, with reference to FIG. 3, the hardware structure of the information processing device 10 according to the embodiment of the present invention is described in detail. FIG. 3 is a block diagram of the hardware structure of the information processing device 10 according to the embodiment of the present invention.

The information processing device 10 mainly includes a CPU 901, a ROM 903, and a RAM 905. The information processing device 10 further includes a host bus 907, a bridge 909, an external bus 911, an interface 913, an input device 915, an output device 917, a storage device 919, a drive 921, a connection port 923, and a communication device 925.

The CPU 901 functions as an operation processing device and control device, controlling the entire or part of the operation in the information processing device 10 according to various programs recorded in the ROM 903, the RAM 905, the storage device 919, or a removable recording medium 927. The ROM 903 stores programs and operation parameters for use by the CPU 901. The RAM 905 temporarily stores programs for use in the CPU 901 and parameters modified during program execution as appropriate. These unit and memories are mutually connected via the host bus 907 configured by an internal bus, such as a CPU bus.

The host bus 907 is connected via the bridge 909 to the external bus 911, such as a peripheral component interconnect/interface (PCI) bus.

The input device 915 is an operating unit operated by the user, such as a mouse, a keyboard, a touch panel, a button, a switch, or a lever. The input device 915 may be, for example, a remote control unit (so-called a remote controller) using, for example, infrared ray or other electric waves, or may be an external connection device 929, such as a portable phone or PDA, supporting the operation of the information processing device 10. Furthermore, for example, the input device 915 is configured of an input control circuit that generates an input signal based on information input from a user using the operating unit mentioned above and outputs the input signal to the CPU 901. By operating this input device 915, the user of the information processing device 10 can input various data to the information processing device 10 and can provide an instruction for a process operation.

The output device 917 is configured of a device capable of visually and acoustically notifying the user of the obtained information. Examples of such a device include: display devices, such as a CRT display device, a liquid-crystal display device, a plasma display device, an EL display device, and a lamp; audio output devices, such as a loudspeaker and a headphone; a printer device; a portable phone; and a facsimile machine. For example, the output device 917 outputs the result obtained from various processes performed by the information processing device 10. Specifically, the display device displays the result obtained from various processes performed by the information processing device 10 as text or image. On the other hand, the audio output device converts an audio signal formed of reproduced audio data, acoustic data, and the like to an analog signal for output.

The storage device 919 is a device for data storage configured as an example of the storage unit of the information processing device 10. The storage device 919 is configured of, for example, a magnetic storage device such as a hard disk drive (HDD), a semiconductor storage device, an optical storage device, or a magneto-optical storage device. The storage device 919 stores programs executed by the CPU 901 and various data, and acoustic signal data and image signal data obtained from the outside.

The drive 921 is a recording-medium reader/writer, and is incorporated in or provided external to the information processing device 10. The drive 921 reads information recorded on a removable recording medium 927 inserted in the drive 921, such as a magnetic disk, an optical disk, a magneto-optical disk, or a semiconductor memory, for output to the RAM 905. The drive 921 can also write a record in the removable recording medium 927 inserted in the drive 921, such as a magnetic disk, an optical disk, a magneto-optical disk, or a semiconductor memory. Examples of the removable recording medium 927 include a DVD medium, an HD-DVD medium, and a Blu-ray medium. Also, the removable recording medium 927 may be a CompactFlash® (CF), a memory stick, or a secure digital (SD) memory card, for example. Furthermore, the removable recording medium 927 may be an integrated circuit (IC) card having a non-contact-type IC chip, or may be electronic equipment, for example.

The connection port 923 is a port for directly connecting a unit to the information processing device 10. Examples of the connection port 923 include a universal serial bus (USB) port, an IEEE 1394 port such as i.Link, and a small computer system interface (SCSI) port. Other examples of the connection port 923 include an RS-232C port, an optical audio terminal, and a high-definition multimedia interface (HDMI) port. With the external connection device 929 connected to this connection port 923, the information processing device 10 directly obtains various data from the external connection device 929 and provides various data to the external connection device 929.

The communication device 925 is, for example, a communication interface configured of a communication device or the like for connection to a communication network 931. Also, the communication device 925 is, for example, a communication card for a wired or wireless local area network (LAN), Bluetooth, or wireless USB (WUSB).

Furthermore, the communication device 925 may be a router for optical communication, a router for an asymmetric digital subscriber line (ADSL), or a modem for various communications, for example. The communication device 925 can transmit and receive a signal and others over the Internet or from and to another communication device, according to a predetermined protocol, such as TCP/IP, for example. Still further, the communication network 931 connected to the communication device 925 is configured of, for example, a network connected in a wired or wireless manner, and may be, for example, the Internet, an in-house LAN, infrared-ray communication, radio-wave communication, or satellite communication.

The description above is made to an example of hardware structure capable of achieving the function of the information processing device 10 according to the embodiment of the present invention. Each component described above may be configured by using a general-purpose member, or may be configured of hardware specific to the function of the component. Therefore, the hardware structure for use can be changed as appropriate according to the technical level at the time of implementing the embodiment.

### CONCLUSION

As described in the foregoing, in the information processing device and operation verifying method according to the embodiments of the present invention, verification of a scalar multiplication operation can be performed in a simple manner by using the operated point P in the scalar multiplication operation, the exponentiation point Q representing the operation result of the scalar multiplication operation, and the base point G of the elliptic curve.

In more detail, in the information processing device and operation verifying method according to the embodiments of the present invention, the operation result can be verified only with four additions and one operation of comparing points. Therefore, in the information processing device and operation verifying method according to the embodiments of the present invention, the validity of the operation result of the scalar multiplication operation can be easily verified irrespectively of the type of elliptic curve without performing a complex process, such as calculation of exponentiation of a predetermined value.

Also, in the information processing device and operation verifying method according to the embodiments of the present invention, the addition/comparison process on the elliptic curve can also be used without a comparison process in the finite field. Therefore, when the operation verifying method according to the embodiments of the present invention is implemented as hardware, the circuit size for the operation verifying method can be small-sized. Also, when the information processing device and operation verifying method according to the embodiments of the present invention is implemented as software, calculation cost can be reduced.

The present application contains subject matter related to that disclosed in Japanese Priority Patent Application JP 2009-105585 filed in the Japan Patent Office on Apr. 23, 2009, the entire content of which is hereby incorporated by reference.

While the preferred embodiments of the present invention have been described in detail with reference to the attached drawings, they are not a limitation. It is evident that a person in the art to which the present invention belongs can devise various examples of change and modification within the range of the technical idea described in the claims, and it is understood that such examples are naturally within the technical range of the present invention.

What is claimed is:

1. An information processing device comprising:
a scalar multiplication operating unit calculating, based on a point P on an elliptic curve E defined on a predetermined defined field, a point Q=s·P by scalar-multiplying the point P; and
an operation verifying unit verifying whether equation (1) below holds by using the point P on the elliptic curve E, the point Q=s·P calculated by the scalar multiplication operating unit, and an arbitrary point G on the elliptic curve E.
(P+Q)+G=P+(Q+G) (1)

2. The information processing device according to claim 1, wherein the elliptic curve E is an elliptic curve E_{A}: y²=x³+ax+b (a, bεF_{q}) defined on a finite field F_{q} (q=p^{m}, mεN, p>3) or an elliptic curve E_{B}: y²+xy=x³+a₂x²+a₆ (a₂, a₆εF_{2̂m}) defined on a finite field F_{2̂m}(mεN) of a characteristic of 2.

3. The information processing device according to claim 2, wherein when equation (1) in claim 1 does not hold, the operation verifying unit determines that the point P does not have a suitable value or the point Q has been tampered.

4. The information processing device according to claim 1, further comprising a storage unit storing hidden information to be hidden by the information processing device, wherein the arbitrary point G on the elliptical curve E is stored in the storage unit as the hidden information.

5. The information processing device according to claim 1, wherein:
the storage unit stores a secret key d held by the information processing device; and
the scalar multiplication operating unit uses the secret key d as a coefficient s for a scalar multiplication operation.

6. The information processing device according to claim 1, wherein the operation verifying unit verifies whether equation (1) in claim 1 holds by using a public key held by the information processing device or a public key held by another reliable information processing device, in place of the point P or the point Q.

7. An operation verifying method comprising the steps of:
calculating, based on a point P on an elliptic curve E defined on a predetermined defined field, a point Q=s·P by scalar-multiplying the point P; and
verifying whether equation (1) in claim 1 holds by using the point P on the elliptic curve E, the calculated point Q=s·P, and an arbitrary point G on the elliptic curve E.

8. A program causing a computer to perform:
a function of calculating, based on a point P on an elliptic curve E defined on a predetermined defined field, a point Q=s·P by scalar-multiplying the point P; and
a function of verifying whether equation (1) in claim 1 holds by using the point P on the elliptic curve E, the point Q=s·P calculated by the scalar multiplication operation function, and an arbitrary point G on the elliptic curve E.
